(19) United States
(12) Patent Application Publication
(10) Pub. No.: US 2016/0270367 A1
(43) Pub. Date: Sep. 22, 2016

(54) Folding utility table for trailers, campers, and/or recreational vehicles

(71) Applicant: Kevin DeWitt, Powell Butte, OR (US)

(72) Inventor: Kevin DeWitt, Powell Butte, OR (US)

(21) Appl. No.: 14/658,614

(22) Filed: Mar. 16, 2015

(51) Int. Cl. A01K 5/01; B60P 3/04; A01K 5/00

(52) U.S. Cl. CPC A01K 5/01; A01K 5/008; B60P 3/04

(57) ABSTRACT

The preferred embodiment of the present invention is a folding feed device adapted to mount to a horse trailer. The device includes a vertical frame member configured to couple to a sidewall of the horse trailer and a hingeable bottom (or horizontal) frame and feeding tray assembly whereby the feeding tray is operable from a first vertical closed position to a second, horizontal open position. The feeding tray is a substantially flat, planar surface. At least one support chain links from an outer edge of the feeding tray to a position on the intermediate horizontal truss whereby in the first closed position the chain is loose and fits between the feeding tray and the vertical frame member and in the second, horizontal open position the chain is taught and configured to retain the feeding tray in the horizontal position.

### PRIORITY CLAIM

The present application claims benefit under 35 USC Section 119(e) of U.S. Provisional Patent Application Ser. No. 61/948,958 filed on 2014 Mar. 20: The present application is based on and claims priority from this application, the disclosure of which is hereby expressly incorporated herein by reference.

### FIELD OF THE INVENTION

The present invention relates to collapsible accessories for utility trailers, camp trailers, recreational trailers, and the like, and more specifically to a folding feeding and watering device for a horse trailer.

### BACKGROUND

The present invention specifically relates to horse trailers, however, the utility of the invention is equally applicable to other livestock feeding stations or other folding apparatus mounted to a fixed wall or to a wall on a movable trailer where a slim, folded profile is desired when not in use, yet provide a sturdy horizontal support surface when in use.

Horse trailers are not only designed to safely transport horses between locations, they are often used as a temporary, mobile shelter replete with feeding and watering stations. During transit, horses are occasionally removed from the trailer to allow the horses to have a break outside the trailer.

Often, the horses are tied to the trailer so that they may be fed and watered and otherwise caring for the animals. To facilitate feeding, some horse trailers include baskets coupled to the side of the trailer, other examples include temporarily suspending a bag to the side of the trailer.

However, these prior solutions are problematic. First, in an attempt to maximize fuel economy when pulling a horse-laden trailer, it is undesirable to have items jutting out from the sidewalls of the trailer. Not only does this present potential harm to pedestrians, the overall girth of such items on the exterior of the trailer increase wind resistance, hinders view from the pull-vehicle's side mirrors, and can potentially damage the trailer by striking roadside objects. Second, many horse trailer's combined with the pull vehicle and the additional value of the livestock represent hundreds of thousands of dollars investment. With this level of expenditure there is an intrinsic pride-of-ownership that demands aesthetically pleasing designs along with improved functionality.

Therefore, there remains a need for a fold-down feeding device that presents a very slim profile when closed, yet appears elegant and high-end when mounted to the trailer. Further, the feeding device needs to support the weight of several bales of hay or other feed material. Such a device should be easy to use, quick to deploy, easy to remove if unwanted, and be robust for multiple uses in normal conditions and offer a low profile to improve fuel economy of the pull-vehicle.

### DRAWING

FIG. 1 is an offset frontal view of a first preferred embodiment of a folding feeding device according to the present invention.

FIG. 2 is an offset frontal view of a second preferred embodiment of folding feeding device according to the present invention.

FIG. 3 is an offset frontal view of a third preferred embodiment of folding feeding device according to the present invention.

FIG. 4 is an assembly view of components of folding feeding device according to any one of the first three preferred embodiments of the present invention.

FIG. 5 is an offset frontal view of a system utilizing any one of the first three preferred embodiments of folding feeding device.

FIG. 6 shows a folding feeding device in a typical environment of use.

FIG. 7 shows an improved horse trailer according to a fourth preferred embodiment of the present invention.

FIG. 8 shows one possible hinge mechanism for enabling hingeable coupling of the vertical frame member to the horizontal frame member according to any at least one of the first three embodiments of the present invention.

FIG. 9 is an exploded front view of components of the vertical frame member according to any at least one of the first three embodiments of the present invention.

FIG. 10 is an exploded top view of components of the horizontal frame member according to any at least one of the first three embodiments of the present invention.

FIG. 11 is an offset frontal view of a feedbag adapted for use with the folding device of the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

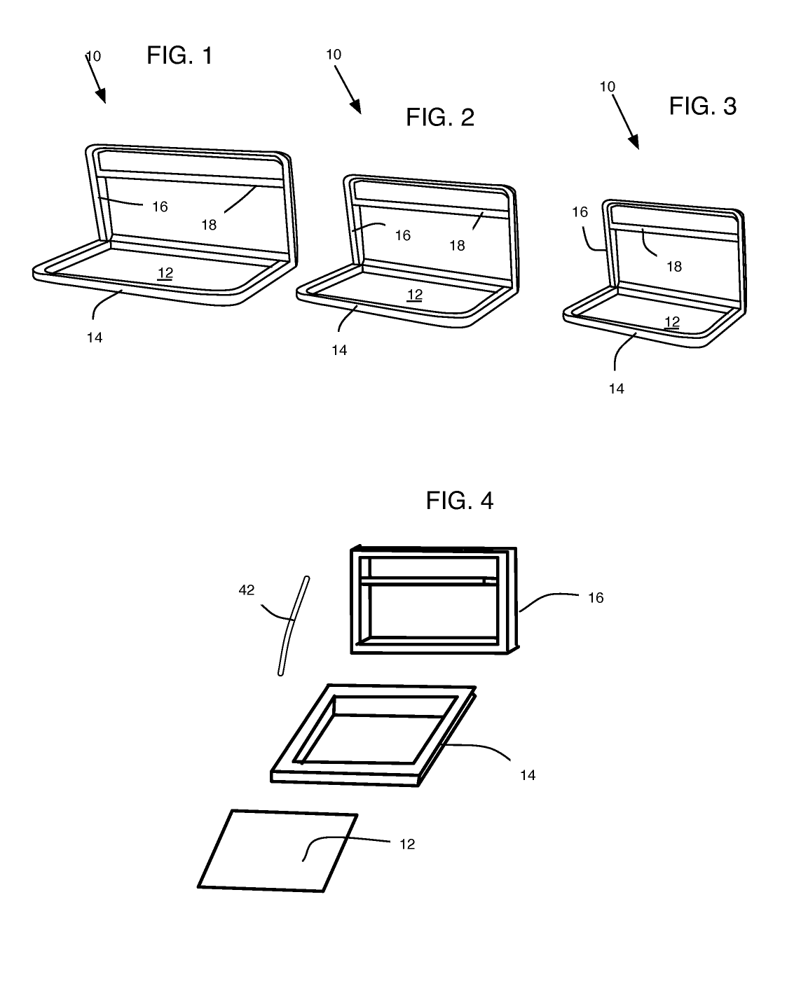

FIGS. 1-4 illustrate a folding feeding device 10 according to various preferred embodiments of the present invention. The embodiments of FIGS. 1-4 are operationally and functionally the same. The primary difference is the overall width: FIG. 1 illustrates a 24-inch wide feeding device, FIG. 2 illustrates a 36-inch wide device, and FIG. 3 illustrates a 48-inch wide device. And, FIG. 4 illustrates a generic feeding device 10 according to the spirit and scope of the present invention.

Referring generally to embodiments one, two and three, the folding feeding device 10 includes a vertical (or upper) frame member 16 configured to couple to a sidewall of the horse trailer, or a wall, or a sidewall of any utility trailer, for example.

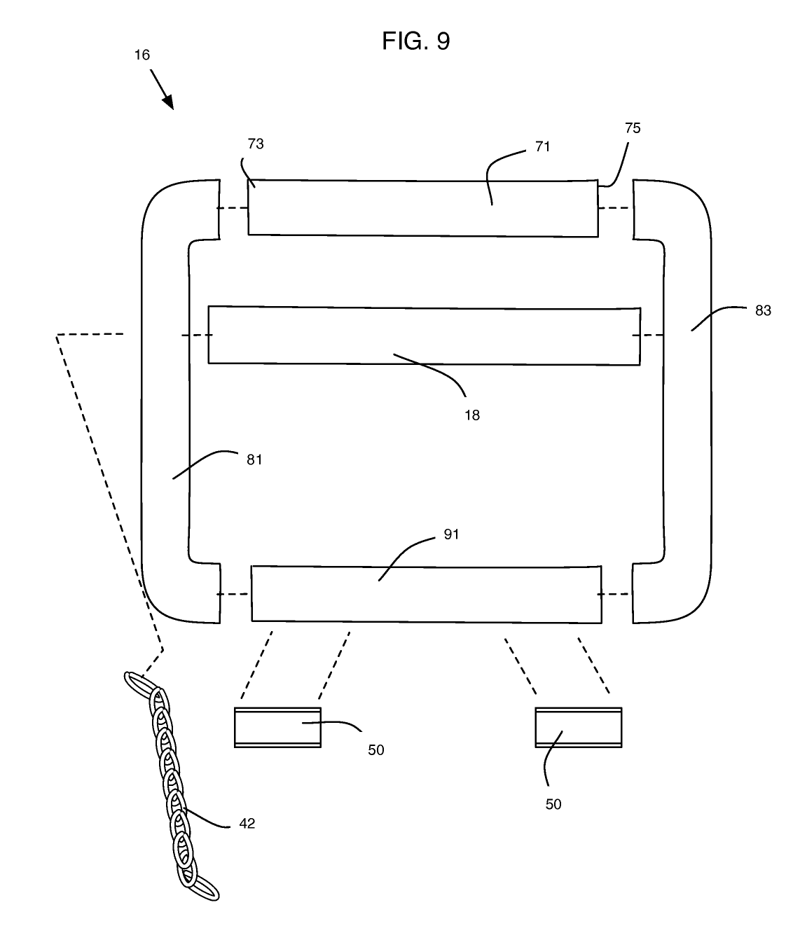

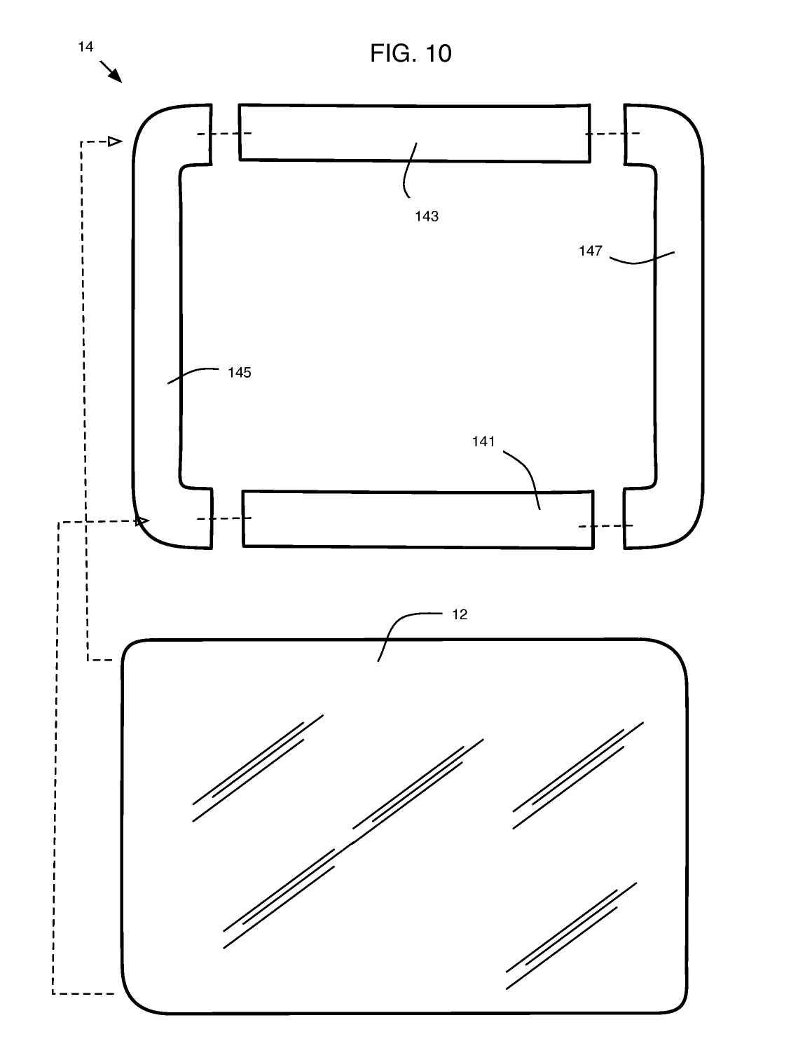

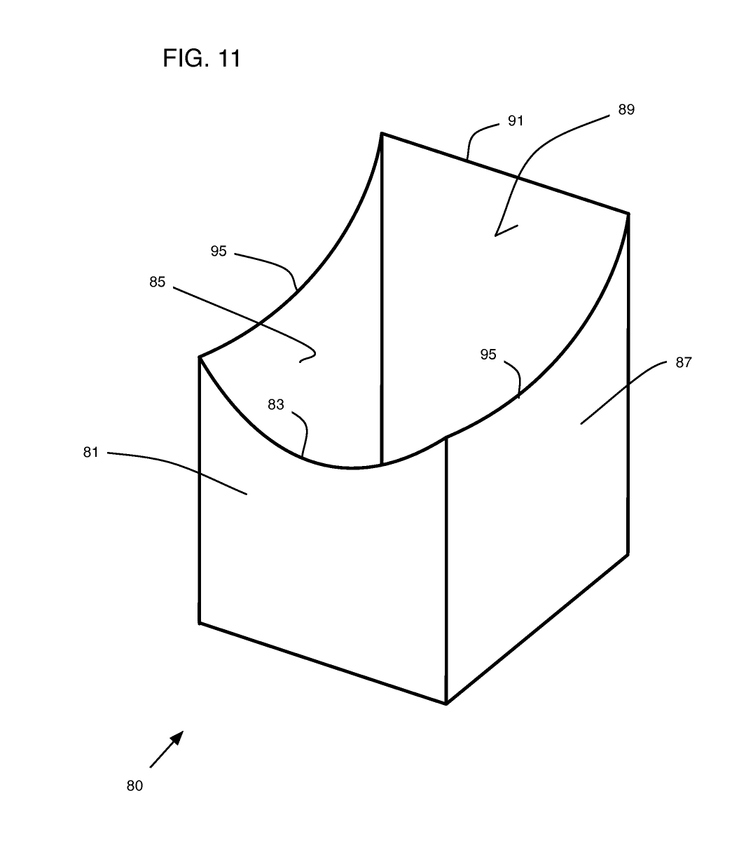

With regard to the first three embodiments as illustrated in FIGS. 1, 2, and, 3, FIGS. 8-10 illustrate common components adapted for use in this folding feeding device 10. As such, a hinge member 50, for example a piano-type hinge, or a plurality of conventional hinges including butt hinges, projection hinges, parliament hinges, and the like, attaches to the vertical frame member 16. And, FIG. 11 illustrates a feedbag 80, which is sized appropriately depending on the size or embodiment of the folding device it is used with. The feedbag 80 rests on the tray and/or lower frame (vertical frame member) of the folding device. It is similar in material and construction of known feedbags, with particular differences further described, below.

The vertical frame member 16 includes a top horizontal truss 71 having a first 73 and second end 75. The first end connects to a first vertical leg 81 and the second end connects to a second vertical leg 83. A bottom horizontal truss 91 links the first and second vertical legs at a position opposite from the top horizontal truss, and an intermediate horizontal linking truss 18 extends from an intermediate position on the first vertical leg to a corresponding intermediate position on the second vertical leg whereby the top horizontal truss, the bottom horizontal truss, and the intermediate horizontal linking truss are all parallel to each other. The vertical frame member has an open center and is generally rectilinear when viewed from the front and substantially flat and planar when viewed in profile, with each aforementioned truss arranged in a common plane.

The lower or horizontal frame 14 includes a feeding tray 12. The feeding tray is a substantially flat, planar surface. This lower frame and tray assembly is hingeably coupled to the vertical frame member 16 by a hinge 50 or other hinge-like feature such as opposing pins inserted into receiving holes, which arranges along an edge of the bottom horizontal truss of the vertical frame 16.

The lower frame 14 further includes a front truss 141 and an opposite and parallel back truss 143 and a left 145 and right truss 147. Each truss is arranged to form a substantial flat and co-planar rectilinear assembly. Further, the tray 12 is operable from a first vertical closed position to a second, horizontal open position. A hinge member 50 couples to both the upper frame 16 and the lower frame 14. A plurality of hinge members, in other preferred embodiments, arranges on one of the frame members (for example the vertical frame member) in a conventional manner, and is further coupled to either the horizontal frame member, or the tray, or both, to enable hinged connection between the vertical frame and the horizontal frame, the tray, or both.

To add extra strength to the cooperating vertical frame 16 and hinged lower frame 14, at least one support chain 42 is configured to link from an outer edge of the tray 12 to a position on the intermediate horizontal truss whereby in the first closed position the chain is loose and fits between the feeding tray and the vertical frame member and in the second, horizontal open position the chain is taught and configured to retain the feeding tray in the horizontal position.

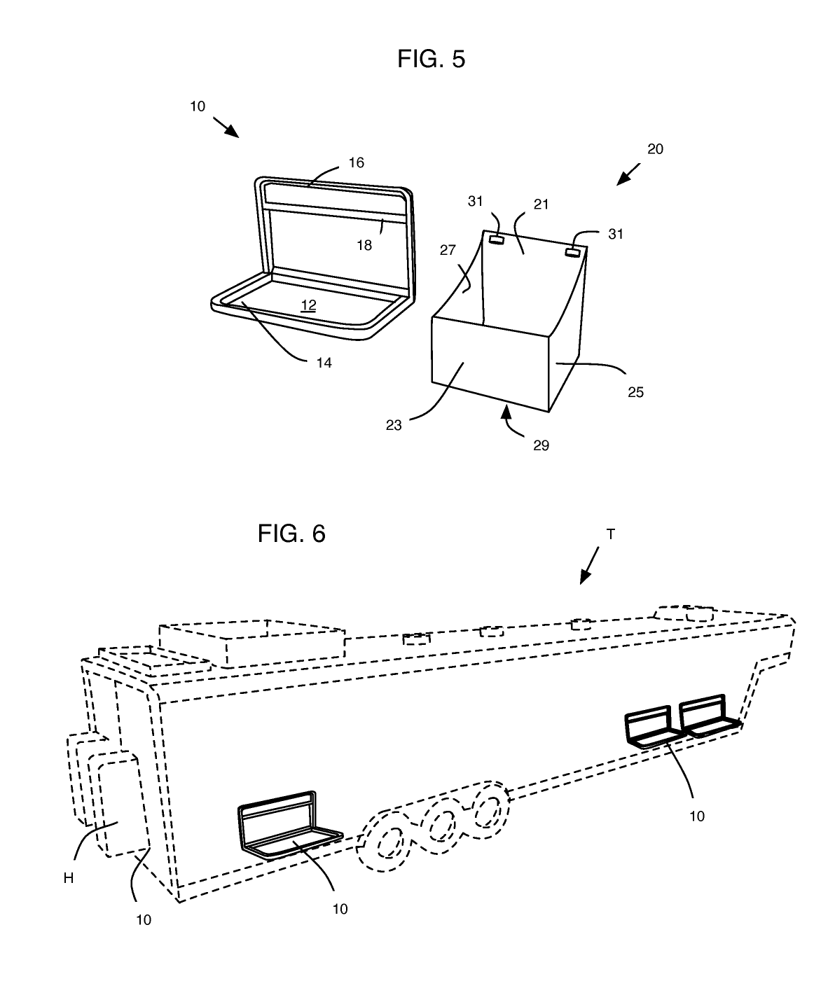

FIG. 5 shows a system incorporating a device 10 according any one of the preferred embodiments of the present invention. The system includes a bag 20 (or alternatively feedbag 80 of FIG. 11) configured to sit on the tray 12 of the device 10. The bag further includes at least one and, preferably, a plurality of mounting holes 31, which enable the bag to be fastened to the vertical frame member 16 of the folding feeding device 10. The bag 20 includes a bottom wall 29, a back wall 21 having a height higher than a corresponding front wall 23 and two oppositely arranged sidewalls 25 and 27. The aforementioned walls arrange to define a volume having an open top.

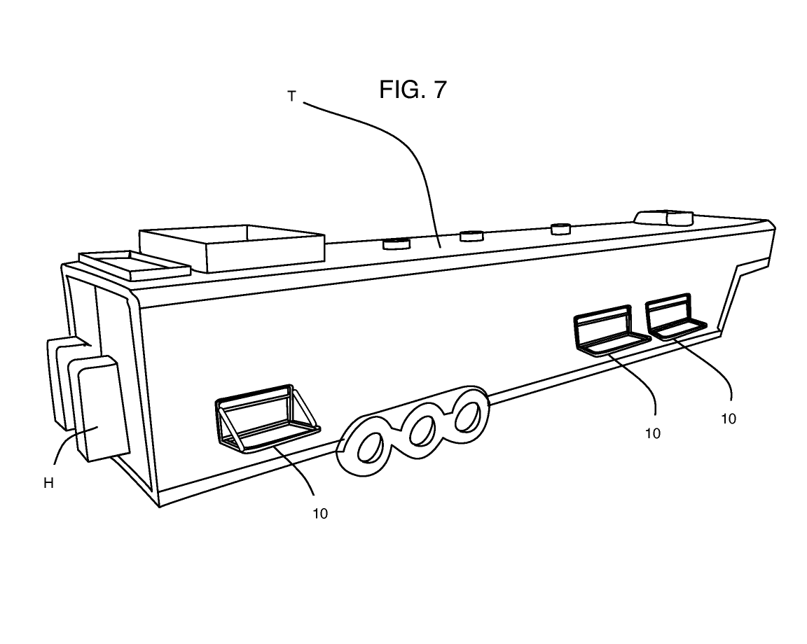

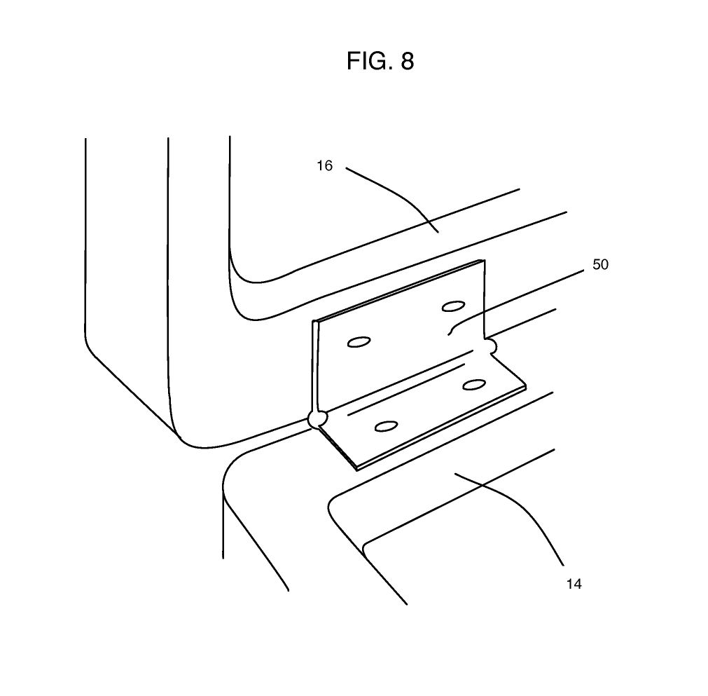

FIGS. 6 and 7 show a typical horse trailer T. A device 10 according to any of the preferred embodiments attaches conventionally to a sidewall or door of the trailer. Hay H stacks on the device 10. The device 10 can be folded flat and stored in a vertical position while still mounted on the trailer. The folding feeding device 10 can mount to an interior wall or an exterior wall of any trailer T, but is particularly useful on a horse trailer. The device can be used to feed animals, but also can be used as a work surface, for example.

The frame members and tray can be fabricated from steel, aluminum, plastic, other metals and their alloys as would be understood in the art. The bag can be made out of a synthetic fabric, canvas, or other suitable materials. The hinge 50 can, in the case of a plastic or other composite material, be integrated into either one or both of the frame members.

The device can be hung from a fence by a hook or wire.

A feedbag 80, such as the feedbag illustrated in FIG. 11, includes an open top and four cooperating sidewalls coupled to bottom wall. The front sidewall 81 includes a curved top edge 83 to facilitate feeding a horse. Each side wall (left sidewall 85 and right sidewall 87) couple to the front sidewall and connect to the rear sidewall 89 to form a generally and substantially rectilinear bag. The bottom sidewall (not viewable in FIG. 11) couples to each of the sidewalls in a conventional manner. The back wall has a top edge 91 that is substantially straight. The sidewalls 85 and 87 have either a respective curvilinear top edge 95 or a sloping top edge. The feedbag is constructed of a fabric, such as canvas, so it can be folded when not in use, for example. The bag is sized and otherwise configured to rest on the tray or horizontal frame member (or both) of the folding feeding device 10 (not shown in FIG. 11). Mounting holes (not shown in FIG. 11), such as the mounting holes 31 illustrated in the bag 20 of FIG. 5, arrange on the backwall of the feedbag 80 to facilitate selective coupling or hanging of the feedbag 80 to the vertical frame.

Those skilled in the art will appreciate that the folding feeding device 10 of the present invention readily adapts and configures for use, and is otherwise contemplated for use, with recreational vehicles, utility trailers, camp trailers and the like—in this form instead of a feeding table for horses—the device configures as a folding utility table, work surface, food-prep surface, dining table, and the like. Further, the device can be mounted to stand proud from the vertical wall to which it attaches, or can be recessed to sit flush with the outside surface of the wall when in the folded position.

Although the invention has been particularly shown and described with reference to certain embodiments, it will be understood by those skilled in the art that various changes in form and detail may be made without departing from the spirit and scope of the invention.

I claim:

1. A folding device adapted to mount to a vertical wall, the device comprising:
a vertical frame member configured to couple to the vertical wall, the vertical frame member comprising a top horizontal truss having a first and second end, the first end connected to a first vertical leg, and the second end connected to a second vertical leg, a bottom horizontal truss links the first and second vertical legs at a position opposite from the top horizontal truss, and an intermediate horizontal linking truss extends from an intermediate position on the first vertical leg to a corresponding intermediate position on the second vertical leg whereby the top horizontal truss, the bottom horizontal truss, and the intermediate horizontal linking truss are all parallel to each other;
a tray hingeably coupled to the vertical frame member at the bottom horizontal truss whereby the tray is operable from a first vertical closed position to a second, horizontal open position, the feeding tray comprising a substantially flat, planar surface; and
at least one support chain configured to link from an outer edge of the tray to a position on the intermediate horizontal truss whereby in the first closed position the chain is loose and fits between the tray and the vertical frame member and in the second, horizontal open position the chain is taught and configured to retain the tray in the horizontal position.

2. The device of claim 1 wherein the feeding tray further comprises:
a lower horizontal frame comprising a front truss and an opposite and parallel back truss and a left and right truss wherein each truss cooperates and configures to arrange to form a substantial flat and co-planar rectilinear assembly, the back truss configures to hingeably couple to the bottom horizontal truss to enable the feeding tray to be operable from a first vertical closed position to a second, horizontal open position.

3. The device of claim 1 further comprising:
a feeding bag configured to sit on the tray.

4. An improved horse trailer having at least one sidewall, the improvement comprising at least one folding feeding device, the folding feeding device comprises:
a vertical frame member configured to couple to a sidewall of the horse trailer, the vertical frame member comprising a top horizontal truss having a first and second end, the first end connected to a first vertical leg, and the second end connected to a second vertical leg, a bottom horizontal truss links the first and second vertical legs at a position opposite from the top horizontal truss, and an intermediate horizontal linking truss extends from an intermediate position on the first vertical leg to a corresponding intermediate position on the second vertical leg whereby the top horizontal truss, the bottom horizontal truss, and the intermediate horizontal linking truss are all parallel to each other;
a tray hingeably coupled to the vertical frame member at the bottom horizontal truss, the tray comprising a substantially flat, planar surface; a lower frame comprising a front truss and an opposite and parallel back truss and a left and right truss wherein each truss cooperates and configures to arrange to form a substantial flat and co-planar rectilinear assembly, which is coupled to the substantially flat, planar surface and wherein the back truss configures to hingeably couple to the bottom horizontal truss to enable the tray to be operable from a first vertical closed position to a second, horizontal open position;
and
at least one support chain configured to link from an outer edge of the tray to a position on the vertical frame member whereby in the first closed position the chain is loose and fits between the tray and the vertical frame member and in the second, horizontal open position the chain is taught and configured to retain the feeding tray in the horizontal position.

5. The device of claim 4 further comprising:
a feeding bag configured to sit on the tray.

6. A folding feeding device comprising:
a vertical frame member configured to couple to the vertical wall, the vertical frame member comprising a top horizontal truss having a first and second end, the first end connected to a first vertical leg, and the second end connected to a second vertical leg, a bottom horizontal truss links the first and second vertical legs at a position opposite from the top horizontal truss, and an intermediate horizontal linking truss extends from an intermediate position on the first vertical leg to a corresponding intermediate position on the second vertical leg whereby the top horizontal truss, the bottom horizontal truss, and the intermediate horizontal linking truss are all parallel to each other;
a horizontal frame member hingeably coupled to the vertical frame member at the bottom horizontal truss, the horizontal frame member comprising a tray and whereby the tray is operable from a first vertical closed position to a second, horizontal open position, the feeding tray comprising a substantially flat, planar surface.

7. The device of claim 6 further comprising:
at least one support chain configured to link from an outer edge of the horizontal frame member to a position on the intermediate horizontal truss whereby in the first closed position the chain is loose and fits between the tray and the vertical frame member and in the second, horizontal open position the chain is taught and configured to retain the tray in the horizontal position.

8. The device of claim 6 wherein the horizontal frame member further comprises:
a front truss and an opposite and parallel back truss and a left and right truss wherein each truss cooperates and configures to arrange to form a substantial flat and co-planar rectilinear assembly, the back truss configures to hingeably couple to the bottom horizontal truss.

9. The device of claim 6 further comprising:
a feeding bag configured to sit on the tray.
